(19) United States
(12) Patent Application Publication
(10) Pub. No.: US 2009/0148565 A1
(43) Pub. Date: Jun. 11, 2009

(54) FLAVORING AGENTS

(75) Inventors: Primo BADER, Sarasota, FL (US); Markus ECKERT, Ramsey, NJ (US); Doug EISENHOFFER, Dover, NJ (US); Paul RIKER, Emerson, NJ (US); Steve PHELPS, Tampa, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: KERRY GROUP SERVICES INTERNATIONAL, LTD., Tralee (IE)

(21) Appl. No.: 12/267,281

(22) Filed: Nov. 7, 2008

Related U.S. Application Data
(60) Provisional application No. 60/986,189, filed on Nov. 7, 2007.

(51) Int. Cl. A23L 1/30

(52) U.S. Cl. 426/72

(57) ABSTRACT

The invention provides a flavoring agent comprising animal tissue or flesh extract, fruit or vegetable seed, leaf, bark, or herbaceous compound extract and a process for preparing the flavoring agent. The flavoring agent can be used in a variety of food products.

### BACKGROUND OF THE INVENTION

The use of fruit, vegetable, and animal materials in the preparation of food products has been practiced for many years in a number of ways. For example, fruits, vegetables, and animal materials have been used as nutritional or dietary supplements, additives, and flavoring agents for food products. Typically, only certain components of the fruit, vegetable, and animal materials (e.g., juice) are used in the preparation of such products. Many of the beneficial vitamins, oils, and other nutrients found in such materials, however, are contained within portions of those materials which are difficult to process and are typically discarded rather than used to prepare food additives or products. For example, the seeds of fruits and vegetables are generally one of the most nutritionally rich components because they can contain antioxidants and beneficial fatty acids (e.g., omega-3 and -6 fatty acids), but are generally removed and discarded during processing. This failure to take advantage of some of the most nutritious portions of fruit, vegetable, and animal materials is unfortunate, especially given the recent obesity epidemic and emphasis on natural, healthy foods. There is a need in the art for commercially viable fruit, vegetable, and animal products that effectively utilize the critical nutrients present in such components.

### BRIEF SUMMARY OF THE INVENTION

The invention provides a flavoring agent comprising animal tissue or flesh extract, fruit seed extract, vegetable seed extract, leaf extract, bark extract, herbaceous compound extract, or combinations thereof. The extract contains vitamins, minerals, and nutrients, such as fatty acids (e.g., omega-3, -5, and -6 fatty acids) and antioxidants (e.g., phenolic compounds) which have been extracted or otherwise removed from the tissue, flesh, seeds, leaves, bark, or herbaceous compounds. Thus, the resulting flavoring agent contains beneficial nutrients which are typically discarded during processing. In order to preserve and enhance its nutritional and health benefits, the inventive flavoring agent is preferably substantially free of non-naturally occurring components, such as non-natural preservatives, chemically modified food starches, non-natural colors, and/or non-natural solvents.

The invention also provides a process for preparing a flavoring agent comprising animal tissue or flesh extract, fruit or vegetable seed, leaf, bark, or herbaceous compound extract wherein the extract is prepared by super critical C0₂ extraction.

The invention also provides an edible food product, such as a beverage, snack bar, cereal, or dietary supplement, comprising a flavoring agent wherein the flavoring agent comprises animal tissue or flesh extract, fruit or vegetable seed, leaf, bark, or herbaceous compound extract.

### BRIEF DESCRIPTION OF THE SEVERAL VIEWS OF THE DRAWING(S)

FIG. 1 is a graph of oxygen radical absorbance capacity (ORAC) (μmol TE/ml) versus shelf life in months for various soft drinks comprising green tea, black tea, green and black tea, rooibos, chamomile, or citrus extract.

### DETAILED DESCRIPTION OF THE INVENTION

In accordance with the invention, a flavoring agent comprising nutrients and/or nutritionals derived from the Kingdom Animalia or the Kingdom Plantae is provided. It has been discovered that the nutritional value of a flavoring agent can be increased or otherwise enhanced by including the desired extract or a mixture of extracts from material derived from the Kingdom Animalia or the Kingdom Plantae as an integral component of the flavoring agent.

Extracts from the Kingdom Plantae include, for example, extracts derived from fruit seeds, vegetable seeds, leaves, bark, herbaceous compounds, as well as all of the various combinations thereof. Preferably, the flavoring agent comprises fruit seed or vegetable seed extract. The terms fruit and vegetable as used herein include any part of a plant that can be consumed by humans, such as, for example, traditional foods like apples, strawberries, peas, and corn, to herbs, spices, and anything else derived from the taxon of organisms that fall within the Kingdom Plantae, as well as all of the various combinations thereof.

Extracts from the Kingdom Animalia include, for example, extracts derived from tissue or flesh from the taxon of organisms that fall within the Kingdom Animalia, including red meat, pork, poultry, fish, wild game, as well as all of the various combinations thereof.

The extracts can be processed in any suitable manner which results in the removal of the desired nutrients contained within the target component. Such methods are well known to those of ordinary skill in the art and can include expellor pressing, vacuum and centrifugal concentration, distillation and recapture of volatile extractions, and selective molecular sieve extraction and concentration. Typically, a supercritical fluid extraction is performed using carbon dioxide (CO₂). Carbon dioxide is compressed at pressures above 73 bar and temperatures above 31° C. in order to transform the CO₂ into a dense gas with a high solvating capacity. The supercritical CO₂ gas has the ability to extract the desired nutrients from the fruit or vegetable component. The solvating capacity of supercritical CO₂ is a function of the density of the carbon dioxide gas, thus the type and quantity of desired nutrients can be selected for extraction by varying the density of the gas along with pressure. The component to be extracted is placed in a sealed container, carbon dioxide is pumped into the container, the mixture is pressurized, and the supercritical carbon dioxide is circulated throughout the container until the desired component:CO₂ ratio is achieved. The pressure is then reduced, allowing the CO₂ to return to its gaseous form, and the extract is removed. Supercritical CO₂ extraction generally results in cleaner, solvent-free extracts, and is more efficient than other extraction methods, such as, for example, pressing.

Any desired nutrients can be extracted from the target component. Such nutrients include proteins, phytochemicals, fatty acids, antioxidants, vitamins, and minerals. Preferably, the component contains omega fatty acids and antioxidants. For example, omega fatty acids, such as the omega-3 fatty acids (e.g., a-linolenic acid), omega-5 fatty acid glycerol esters, and omega-6 fatty acids can be found within the seeds of certain fruits and vegetables. In addition, antioxidants such as phenolic compounds (e.g., polyphenols) and anthocyanin compounds are also commonly found within the seeds of certain fruits and vegetables. Similarly, such nutrients can also be found in and extracted from leaves, bark, and herbaceous compounds derived from fruits and vegetables or from animal tissue or flesh.

The seed extract can have any suitable amount of omega-3 fatty acid. The amount of omega-3 fatty acid in the seed extract is preferably at least about 5 wt. % (e.g., at least about 10 wt. %, at least about 20 wt. %, at least about 30 wt. %, or at least about 50 wt. %). The amount of omega-3 fatty acid in the seed extract is preferably about 90 wt. % or less (e.g., about 80 wt. % or less, about 70 wt. % or less, or about 60 wt. % or less). The amount of omega-3 fatty acid in the seed extract is, for example, about 5 wt. % to about 90 wt. %, about 10 wt. % to about 80 wt. %, about 20 wt. % to about 70 wt. %, or about 30 wt. % to about 70 wt. %. Similarly, such amounts of omega-3 fatty acids can be found in extracts from leaves, bark, and herbaceous compounds from fruits and vegetables or from animal tissue or flesh.

The seed extract can have any suitable amount of omega-6 fatty acid. The amount of omega-6 fatty acid in the seed extract is preferably at least about 0.01 wt. % (e.g., at least about 0.5 wt. %, at least about 1 wt. %, at least about 5 wt. %, or at least about 10 wt. %). The amount of omega-6 fatty acid in the seed extract is preferably about 70 wt. % or less (e.g., about 50 wt. % or less, about 40 wt. % or less, or about 30 wt. % or less). The amount of omega-6 fatty acid in the seed extract is, for example, about 0.01 wt. % to about 70 wt. %, about 0.5 wt. % to about 50 wt. %, about 1 wt. % to about 50 wt. %, or about 10 wt. % to about 40 wt. %. Similarly, such amounts of omega-3 fatty acids can be found in extracts from leaves, bark, and herbaceous compounds from fruits and vegetables or from animal tissue or flesh.

Seeds, leaves, bark, or herbaceous compounds from any suitable fruit or vegetable can be used to prepare the extract. For example, seeds, leaves, bark, or herbaceous compounds from cranberry, grape, pomegranate, blueberry, grapefruit, rooibos, orange, lime, melons, apple, pear, watermelon, peach, cherry, apricot, pineapple, tangerine, kiwi, raspberry, strawberry, blackberry, and/or tomato can be used. In addition, seeds, leaves, bark, or herbaceous compounds from cucumber, tea, artichoke, carrot, radish, spinach, beet, cumin, cardamom, coriander, ginger, sage, rosemary, lemon balm, marjoram, and basil can also be used. In addition, extracts from different fruit or vegetable sources can be used in the same flavoring agent. For example, the flavoring agent can comprise seed extract from both cranberry and pomegranate sources, or seed extract from both tomato and artichoke sources. Similarly, animal tissue or flesh from any suitable animal source can be used to prepare the extract, including, for example, shrimp, salmon, tuna, pork, beef, and chicken.

The inventive flavoring agent can comprise additional components derived from fruits or vegetables. For example, fruit or vegetable juice, puree, skin, and extract can be added to the flavoring agent comprising the seed, leaf, bark, or herbaceous compound extract. Further, fruit or vegetable flavors can also be added to the flavoring agent. Such flavors generally comprise selected natural flavor substances, preparations, and solvents, for example. These additional materials can be prepared or processed in any of a number of ways which are known to those of ordinary skill in the art. These additional components can be from the same or a different fruit or vegetable source as the seed, leaf, bark, or herbaceous compound extract. For example, the flavoring agent can comprise both seed extract from cranberries and fruit juice from grapes.

Additional components, in any suitable amount, can be added to the flavoring agent in order to enhance or adjust the properties of the flavoring agent, such as concentration, sweetness, stability, and viscosity. Preferably, such components are naturally-occurring substances. For example sugars, maltodextrin, gum arabic, water, and combinations thereof can be added to the flavoring agent. Other components that enhance or increase the nutrient content of the flavoring agent can also be added, such as fatty acids, antioxidants (e.g., polyphenols), and botanical extracts (e.g., aloes, orange blossom, and saffron), especially those with known or suspected health benefits (e.g., weight loss).

Preferably, the flavoring agent is substantially free of non-naturally-occurring components and additives. It is not necessary nor, in the preferred embodiment of this invention, is it desirable, to add non-naturally-occurring components to the flavoring agent. Thus, the flavoring agent is, particularly in the preferred embodiments, substantially free of non-natural preservatives, non-natural colors, non-natural solvents, and chemically modified food starches. The term non-natural, as it relates to the invention described herein, means any component or additive which is artificially created, man-made, or is otherwise not found in or derived from nature.

The flavoring agent can contain any suitable type and amount of nutrients. Such nutrients include proteins, phytochemicals, fatty acids, antioxidants, vitamins, and minerals. Preferably, the flavoring agent contains omega fatty acids and antioxidants, such as omega-3 fatty acids (e.g., a-linolenic acid), omega-5 fatty acid glycerol esters, omega-6 fatty acids, phenolic compounds (polyphenols), astaxanthin, and/or anthocyanin compounds.

The flavoring agent can have any suitable amount of omega-3 fatty acid. The amount of omega-3 fatty acid in the flavoring agent is preferably at least about 10 mg omega-3 fatty acid per gram flavoring agent (e.g., at least about 30 mg omega-3 fatty acid per gram flavoring agent, at least about 50 mg omega-3 fatty acid per gram flavoring agent, at least about 70 mg omega-3 fatty acid per gram flavoring agent, or at least about 100 mg omega-3 fatty acid per gram flavoring agent). The amount of omega-3 fatty acid in the flavoring agent is preferably about 300 mg omega-3 fatty acid per gram flavoring agent or less (e.g., about 250 mg omega-3 fatty acid per gram flavoring agent or less, about 200 mg omega-3 fatty acid per gram flavoring agent or less, or about 180 mg omega-3 fatty acid per gram flavoring agent or less). The amount of omega-3 fatty acid in the flavoring agent is, for example, about 10 mg omega-3 fatty acid per gram flavoring agent to about 300 mg omega-3 fatty acid per gram flavoring agent, about 30 mg omega-3 fatty acid per gram flavoring agent to about 250 mg omega-3 fatty acid per gram flavoring agent, about 50 mg omega-3 fatty acid per gram flavoring agent to about 200 mg omega-3 fatty acid per gram flavoring agent, or about 70 mg omega-3 fatty acid per gram flavoring agent to about 180 mg omega-3 fatty acid per gram flavoring agent.

The flavoring agent can have any suitable amount of omega-5 fatty acid. The amount of omega-5 fatty acid in the flavoring agent is preferably at least about 10 mg omega-5 fatty acid per gram flavoring agent (e.g., at least about 30 mg omega-5 fatty acid per gram flavoring agent, at least about 50 mg omega-5 fatty acid per gram flavoring agent, at least about 70 mg omega-5 fatty acid per gram flavoring agent, or at least about 100 mg omega-5 fatty acid per gram flavoring agent). The amount of omega-5 fatty acid in the flavoring agent is preferably about 300 mg omega-5 fatty acid per gram flavoring agent or less (e.g., about 250 mg omega-5 fatty acid per gram flavoring agent or less, about 200 mg omega-5 fatty acid per gram flavoring agent or less, or about 180 mg omega-5 fatty acid per gram flavoring agent or less). The amount of omega-5 fatty acid in the flavoring agent is, for example, about 10 mg omega-5 fatty acid per gram flavoring agent to about 300 mg omega-5 fatty acid per gram flavoring agent, about 30 mg omega-5 fatty acid per gram flavoring agent to about 250 mg omega-5 fatty acid per gram flavoring agent, about 50 mg omega-5 fatty acid per gram flavoring agent to about 200 mg omega-5 fatty acid per gram flavoring agent, or about 70 mg omega-5 fatty acid per gram flavoring agent to about 180 mg omega-5 fatty acid per gram flavoring agent.

The flavoring agent can have any suitable amount of omega-6 fatty acid. The amount of omega-6 fatty acid in the flavoring agent is preferably at least about 10 mg omega-6 fatty acid per gram flavoring agent (e.g., at least about 30 mg omega-6 fatty acid per gram flavoring agent, at least about 50 mg omega-6 fatty acid per gram flavoring agent, at least about 70 mg omega-6 fatty acid per gram flavoring agent, or at least about 100 mg omega-6 fatty acid per gram flavoring agent). The amount of omega-6 fatty acid in the flavoring agent is preferably about 300 mg omega-6 fatty acid per gram flavoring agent or less (e.g., about 250 mg omega-6 fatty acid per gram flavoring agent or less, about 200 mg omega-6 fatty acid per gram flavoring agent or less, or about 180 mg omega-6 fatty acid per gram flavoring agent or less). The amount of omega-6 fatty acid in the flavoring agent is, for example, about 10 mg omega-6 fatty acid per gram flavoring agent to about 300 mg omega-6 fatty acid per gram flavoring agent, about 30 mg omega-6 fatty acid per gram flavoring agent to about 250 mg omega-6 fatty acid per gram flavoring agent, about 50 mg omega-6 fatty acid per gram flavoring agent to about 200 mg omega-6 fatty acid per gram flavoring agent, or about 70 mg omega-6 fatty acid per gram flavoring agent to about 180 mg omega-6 fatty acid per gram flavoring agent.

The flavoring agent can have any suitable ratio of omega-3 fatty acid to omega-6 fatty acid. The ratio of omega-3 fatty acid to omega-6 fatty acid in the flavoring agent is preferably at least about 1:20 (e.g., at least about 1:10, at least about 1:5, at least about 1:3, or at least about 1:1). The ratio of omega-3 fatty acid to omega-6 fatty acid in the flavoring agent is preferably about 20:1 or less (e.g., about 10:1 or less, about 5:1 or less, or about 3:1 or less). The ratio of omega-3 fatty acid to omega-6 fatty acid in the flavoring agent is, for example, about 1:20 to about 20:1, about 1:10 to about 10:1, about 1:5 to about 5:1, or about 1:3 to about 3:1.

The flavoring agent can have any suitable antioxident capacity. The antioxident capacity of the flavoring agent is preferably at least about 10 μmol trolox equivalents per gram flavoring agent (e.g., at least about 30 μmol trolox equivalents per gram flavoring agent, at least about 50 μmol trolox equivalents per gram flavoring agent, at least about 70 μmol trolox equivalents per gram flavoring agent, or at least about 90 μmol trolox equivalents per gram flavoring agent). The antioxident capacity of the flavoring agent is preferably about 200 μmol trolox equivalents per gram flavoring agent or less (e.g., about 150 μmol trolox equivalents per gram flavoring agent or less, about 120 μmol trolox equivalents per gram flavoring agent or less, or about 100 μmol trolox equivalents per gram flavoring agent or less). The antioxident capacity of the flavoring agent is, for example, about 10 μmol trolox equivalents per gram flavoring agent to about 200 μmol trolox equivalents per gram flavoring agent, about 30 μmol trolox equivalents per gram flavoring agent to about 150 μmol trolox equivalents per gram flavoring agent, about 50 μmol trolox equivalents per gram flavoring agent to about 120 μmol trolox equivalents per gram flavoring agent, or about 70 μmol trolox equivalents per gram flavoring agent to about 100 μmol trolox equivalents per gram flavoring agent.

The flavoring agent can have any suitable water-soluble antioxident capacity. The water-soluble antioxident capacity of the flavoring agent is preferably at least about 10 μmol trolox equivalents per gram flavoring agent (e.g., at least about 30 μmol trolox equivalents per gram flavoring agent, at least about 50 μmol trolox equivalents per gram flavoring agent, at least about 80 μmol trolox equivalents per gram flavoring agent, or at least about 100 μmol trolox equivalents per gram flavoring agent). The water-soluble antioxident capacity of the flavoring agent is preferably about 180 μmol trolox equivalents per gram flavoring agent or less (e.g., about 150 μmol trolox equivalents per gram flavoring agent or less, about 120 μmol trolox equivalents per gram flavoring agent or less, or about 100 μmol trolox equivalents per gram flavoring agent or less). The water-soluble antioxident capacity of the flavoring agent is, for example, about 10 μmol trolox equivalents per gram flavoring agent to about 180 μmol trolox equivalents per gram flavoring agent, about 30 μmol trolox equivalents per gram flavoring agent to about 150 μmol trolox equivalents per gram flavoring agent, about 50 μmol trolox equivalents per gram flavoring agent to about 120 μmol trolox equivalents per gram flavoring agent, or about 80 μmol trolox equivalents per gram flavoring agent to about 130 μmol trolox equivalents per gram flavoring agent.

The flavoring agent can have any suitable lipid-soluble antioxident capacity. The lipid-soluble antioxident capacity of the flavoring agent is preferably at least about 0.5 μmol trolox equivalents per gram flavoring agent (e.g., at least about 1 μmol trolox equivalents per gram flavoring agent, at least about 3 μmol trolox equivalents per gram flavoring agent, at least about 5 μmol trolox equivalents per gram flavoring agent, or at least about 10 μmol trolox equivalents per gram flavoring agent). The lipid-soluble antioxident capacity of the flavoring agent is preferably about 50 μmol trolox equivalents per gram flavoring agent or less (e.g., about 30 μmol trolox equivalents per gram flavoring agent or less, about 15 μmol trolox equivalents per gram flavoring agent or less, or about 10 μmol trolox equivalents per gram flavoring agent or less). The lipid-soluble antioxident capacity of the flavoring agent is, for example, about 0.5 μmol trolox equivalents per gram flavoring agent to about 50 μmol trolox equivalents per gram flavoring agent, about 1 μmol trolox equivalents per gram flavoring agent to about 30 μmol trolox equivalents per gram flavoring agent, about 3 μmol trolox equivalents per gram flavoring agent to about 30 μmol trolox equivalents per gram flavoring agent, or about 5 μmol trolox equivalents per gram flavoring agent to about 15 μmol trolox equivalents per gram flavoring agent.

The flavoring agent can have any suitable amount of phenolic compounds. The amount of phenolic compounds in the flavoring agent is preferably at least about 1 mg of phenolic compounds per gram flavoring agent (e.g., at least about 3 mg of phenolic compounds per gram flavoring agent, at least about 5 mg of phenolic compounds per gram flavoring agent, at least about 8 mg of phenolic compounds per gram flavoring agent, or at least about 10 mg of phenolic compounds per gram flavoring agent). The amount of phenolic compounds in the flavoring agent is preferably about 80 mg of phenolic compounds per gram flavoring agent or less (e.g., about 50 mg of phenolic compounds per gram flavoring agent or less, about 30 mg of phenolic compounds per gram flavoring agent or less, or about 20 mg of phenolic compounds per gram flavoring agent or less). The amount of phenolic compounds in the flavoring agent is, for example, about 1 mg of phenolic compounds per gram flavoring agent to about 80 mg of phenolic compounds per gram flavoring agent, about 3 mg of phenolic compounds per gram flavoring agent to about 50 mg of phenolic compounds per gram flavoring agent, about 5 mg of phenolic compounds per gram flavoring agent to about 30 mg of phenolic compounds per gram flavoring agent, or about 8 mg of phenolic compounds per gram flavoring agent to about 20 mg of phenolic compounds per gram flavoring agent.

The flavoring agent can contain any suitable amount of anthocyanin compounds. The amount of anthocyanin compounds in the flavoring agent is preferably at least about 0. 1 mg of anthocyanin compounds per gram flavoring agent (e.g., at least about 0.3 mg of anthocyanin compounds per gram flavoring agent, at least about 0.5 mg of anthocyanin compounds per gram flavoring agent, at least about 0.8 mg of anthocyanin compounds per gram flavoring agent, or at least about 1 mg of anthocyanin compounds per gram flavoring agent). The amount of anthocyanin compounds in the flavoring agent is preferably about 50 mg of anthocyanin compounds per gram flavoring agent or less (e.g., about 30 mg of anthocyanin compounds per gram flavoring agent or less, about 20 mg of anthocyanin compounds per gram flavoring agent or less, or about 10 mg of anthocyanin compounds per gram flavoring agent or less). The amount of anthocyanin compounds in the flavoring agent is, for example, about 0. 1 mg of anthocyanin compounds per gram flavoring agent to about 50 mg of anthocyanin compounds per gram flavoring agent, about 0.3 mg of anthocyanin compounds per gram flavoring agent to about 30 mg of anthocyanin compounds per gram flavoring agent, about 0.5 mg of anthocyanin compounds per gram flavoring agent to about 20 mg of anthocyanin compounds per gram flavoring agent, or about 0.8 mg of anthocyanin compounds per gram flavoring agent to about 10 mg of anthocyanin compounds per gram flavoring agent.

The flavoring agent can have any suitable ratio of omega-3 fatty acids to oxygen radical absorbance capacity (ORAC). The ratio of omega-3 fatty acids to ORAC of the flavoring agent is preferably at least about 1:10 (e.g., at least about 1:1, at least about 5:1, or at least about 10:1). The ratio of omega-3 fatty acids to ORAC of the flavoring agent is preferably about 80:1 or less (e.g., about 50:1 or less, about 30:1 or less, or about 25:1 or less). The ratio of omega-3 fatty acids to ORAC of the flavoring agent is, for example, about 1:10 to about 80:1, about 1:5 to about 50:1, about 1:1 to about 30:1, or about 5:1 to about 25:1.

The flavoring agent can be prepared in any suitable manner. Typically, several components are combined, followed by a mixing step, after which additional components are added, followed by another mixing step. This process is repeated until all desired components have been added to the mixture.

After all desired components have been added to the mixture to form the flavoring agent, homogenization can continue until the desired particle size is reached. The flavoring agent can have any suitable particle size. The particle size of the flavoring agent is preferably at least about 0.001 microns (e.g., at least about 0.01 microns, at least about 0.1 microns, at least about 0.5 microns, at least about 1 micron, or at least about 3 microns). The particle size of the flavoring agent is preferably about 100 microns or less (e.g., about 50 microns or less, about 30 microns or less, about 10 microns or less, about 5 microns or less, or about 1 micron or less). The particle size of the flavoring agent is, for example, about 0.001 microns to about 100 microns, about 0.01 microns to about 50 microns, about 0.1 microns to about 30 microns, about 0.5 microns to about 10 microns, or about 1 micron to about 10 microns.

The flavoring agent can have any suitable soluble solids content (as measured by degrees Brix). The degrees Brix of the flavoring agent can be measured by using, for example, a digital refractometer (e.g., Reichert ABBE Mark II). The soluble solids content of the flavoring agent is typically used as an indicator of the viscosity of the flavoring agent. The soluble solids content of the flavoring agent is preferably at least about 10° Bx (e.g., at least about 20° Bx, at least about 30° Bx, at least about 40° Bx, or at least about 50° Bx). The soluble solids content of the flavoring agent is preferably about 100° Bx or less (e.g., about 80° Bx or less, about 70° Bx or less, or about 60° Bx or less). The soluble solids content of the flavoring agent is, for example, about 10° Bx to about 100° Bx, about 20° Bx to about 80° Bx, about 30° Bx to about 70° Bx, or about 40° Bx to about 60° Bx.

The flavoring agent can have any suitable acid content (calculated here as % citric acid), as measured by titration (e.g., Mettler DL12 Titrator). The citric acid content of the flavoring agent is preferably at least about 0.01% (e.g., at least about 0.1%, at least about 0.5%, at least about 1%, or at least about 2%). The citric acid content of the flavoring agent is preferably about 30% or less (e.g., about 20% or less, about 10% or less, or about 5% or less). The citric acid content of the flavoring agent is, for example, about 0.01% to about 30%, about 0.1% to about 20%, about 0.5% to about 10%, or about 1% to about 5%.

The flavoring agent can have any suitable moisture content, as measured by titration (e.g., Mettler DL18 Karl Fisher Titrator). The moisture content of the flavoring agent is preferably at least about 0.01 g/100 g flavoring agent (e.g., at least about 0.1 g/100 g flavoring agent, at least about 0.5 g/100 g flavoring agent, at least about 1 g/100 g flavoring agent, or at least about 2 g/100 g flavoring agent). The moisture content of the flavoring agent is preferably about 20 g/100 g flavoring agent or less (e.g., about 10 g/100 g flavoring agent or less, about 7 g/100 g flavoring agent or less, or about 5 g/100 g flavoring agent or less). The moisture content of the flavoring agent is, for example, about 0.01 g/100 g flavoring agent to about 20 g/100 g flavoring agent, about 0.1 g/100 g flavoring agent to about 10 g/100 g flavoring agent, about 0.5 g/100 g flavoring agent to about 7 g/100 g flavoring agent, or about 1 g/100 g flavoring agent to about 5 g/100 g flavoring agent.

The flavoring agent can have any suitable protein content. The protein content of the flavoring agent is preferably at least about 0.001 g/100 g flavoring agent (e.g., at least about 0.01 g/100 g flavoring agent, at least about 0.05 g/100 g flavoring agent, at least about 0.1 g/100 g flavoring agent, or at least about 0.5 g/100 g flavoring agent). The protein content of the flavoring agent is preferably about 5 g/100 g flavoring agent or less (e.g., about 3 g/100 g flavoring agent or less, about 1 g/100 g flavoring agent or less, or about 0.8 g/100 g flavoring agent or less). The protein content of the flavoring agent is, for example, about 0.001 g/100 g flavoring agent to about 5 g/100 g flavoring agent, about 0.01 g/100 g flavoring agent to about 3 g/100 g flavoring agent, about 0.05 g/100 g flavoring agent to about 3 g/100 g flavoring agent, or about 0.1 g/100 g flavoring agent to about 1 g/100 g flavoring agent.

After all of the components have been added to the mixture, the mixture can then be dried if desired using any suitable method, such as freeze drying or spray drying. Preferably, a continuous vacuum dryer is used to freeze dry the mixture. Examples of continuous vacuum dryers and the use thereof are provided in U.S. Pat. Nos. 2,924,271, 2,924,272, 2,924,273, 3,085,018, 3,105,589, 5,024,848, and 5,149,558. The chamber pressure of the drying vessel must be maintained at about 4.33 mm Hg or greater throughout the drying process in order to properly classify the flavoring agent as freeze dried. All other vacuum dryer settings, such as belt speed, temperature zones, and layer thickness applied to the belt, can be adjusted to any suitable setting. The liquid flavoring agent preferably has a viscosity range of about 500 cps to about 25,000 cps at 40° F. in order to be successfully freeze dried using a continuous vacuum dryer. Although not wishing to be bound by any particular theory, it is likely that the carbohydrate and/or protein composition of the flavoring agent plays a role in the characteristics of the flavoring agent when freeze dried using a continuous vacuum dryer.

Spray drying can be accomplished by using an atomizer or similar device to reduce the liquid flavoring agent to fine droplets which can then be dried by exposure to a hot gas, such as air or nitrogen. Alternatively, the flavoring agent can remain in liquid form. Preferably, the liquid flavoring agent is in the form of an emulsion.

The flavoring agent can be used to prepare any of a wide variety of food products. For example, the flavoring agent can be used in food products such as nutritional bars, energy bars, snack bars, beverages (e.g., tea, carbonated soft drinks, sports drinks, powdered drink systems), smoothies and smoothie mixes, cereals, meal replacements (e.g., nutritional shake mixes, etc.), or any suitable edible food product. In addition, the flavoring agent can also be used as a dietary supplement.

The following examples further illustrate the invention but, of course, should not be construed as in any way limiting its scope.

### EXAMPLE 1

This example illustrates the preparation of a freeze dried cranberry flavoring agent.

Water and gum arabic, in the amounts indicated in the table below, were mixed in a rotosolver at 1750 rpm for 5 minutes. Cranberry puree (Milne) and cranberry juice concentrate (Kerr) were added to the mixture, which was then mixed at 2500 rpm for 1 minute. Sugar was then added, the mixture was blended, maltodextrin was added, and the mixture was blended for an additional 5-7 minutes. 2 grams of cranberry seed extract free of astaxantin (Cranberol™ from Valensa) was reconstituted in 100 ml water. The seed extract was then added to the mixture slowly, followed by the flavor (the formulation of which is indicated below in Table 8), over the course of 2 minutes. The mixture was then blended at 2500 rpm for 2 minutes. The mixture was applied to a stainless steel belt using a roller to provide a layer of about 40 ml or more in a chamber maintained at about 10 mm Hg or more. The belt traveled at a rate of about 15 feet/minute and moved the mixture through a vaccuum dryer having various temperature zones in order to dry the mixture. Zone 1a includes the first 10 feet after the roller appllication, and subjected the mixture to a temperature of about 68° F. for about 40 seconds. Zone lb includes the next 30 feet and subjected the mixture to a temperature of about 90-100° F. for about 120 seconds. Zone 2 includes the next 20 feet and subjected the mixture to a temperature of about 140° F. or greater for about 80 seconds. Zone 3 includes the next 40 feet and subjected the mixture to a temperature of about 100° F. or less for about 160 seconds. Zone 4 includes the next 15 feet and subjected the mixture to a temperature of about 40° F. or less for about 60 seconds. A brass doctor blade removed the resulting dry mixture from the belt into a receiving bag, the pressure was raised to atmospheric pressure, and the receiving bag was sealed.

The cranberry flavoring agent formulation is indicated below in Table 1.

TABLE 1

| | Amount | Amount | |
|---|---|---|---|
| Ingredient | (dry %) | (wet %) | °Bx |
| cranberry puree | 5 | 16 | 23.1 |
| cranberry juice | 15 | 23.52 | 47.2 |
| concentrate | | | |
| maltodextrin | 32.57 | 25.38 | 95 |
| granulated sugar | 18.13 | 13.56 | 99 |
| pre-hydrated gum | 12 | 10.2 | 87 |
| arabic | | | |
| cranberry seed extract | 15 | 11.1 | 100 |
| natural cranberry flavor | 0.3 | 0.22 | 100 |
| filtered water | 2 | 0 | 100 |
| total (%) | 100 | 100 | — |

The wet formulation had a citric acid % of 2.39, and an uncorrected ° Bx of 54.3, resulting in a calculated, corrected ° Bx of 54.7.

The properties of the cranberry flavoring agent and cranberry seed extract used to prepare the flavoring agent are indicated below in Table 2.

TABLE 2

| Property | Seed Extract | Flavoring Agent |
|---|---|---|
| moisture (g/100 g) | 2.49 | 3.34 |
| protein (g/100 g) | 0.2 | 0.7 |
| fat (soxhlet method) (g/100 g) | 4.34 | 2.67 |
| fat (acid hydrolysis, Mojonnier | 17.84 | 16.04 |
| method) (g/100 g) | | |
| ash (g/100 g) | 0.56 | 0.4 |

The fatty acid content of the cranberry flavoring agent and cranberry seed extract used to prepare the flavoring agent are indicated below in Table 3.

TABLE 3
Fatty Acid Content (% of total fat)

| Fatty Acid | Seed Extract | Flavoring Agent |
|---|---|---|
| lauric (C12:0) | 0.06 | 0.07 |
| myristic (C14:0) | 0.04 | 0.05 |
| myristoleic (C14:1) | 0.04 | 0.1 |
| palmitic (C16:0) | 5.43 | 5.41 |
| palmitelaidic (C16:1 trans) | 0.07 | 0.04 |
| palmitoleic (C16:1 cis) | 0.05 | 0.04 |
| stearic (C18:0) | 0 | 0.64 |
| elaidic (C18:1 trans) | 0.95 | 0.96 |
| oleic (C18:1 cis) | 20.65 | 20.08 |
| linoelaidic (C18:2 trans) | 0.2 | 0.14 |
| linoleic (C18:2 cis) | 39.69 | 39.71 |
| linolenic (C18:3 cis) | 0.1 | 0.07 |
| arachidic (C20:0) | 0.12 | 0.09 |
| eicosenoice (C20:1 cis) | 0.01 | 0.02 |
| omega-6 (C18:3, n-6) | 0.02 | 0.02 |
| omega-6 (C20:3, n-6) | 0 | 0.01 |
| omega-6 (C20:4, n-6) | 0 | 0.02 |
| omega-3 (C18:3, n-3) | 32.55 | 32.52 |
| omega-3 (C22:6, n-3) | 0.02 | 0.01 |

The scavenging capacity of the antioxidants contained in the cranberry flavoring agent against the peroxyl radical, one of the most common reactive oxygen species found in humans, was measured for both water- and lipid-soluble antioxidants. Trolox, a water-soluble vitamin E analog, was used as the calibration standard and the results are expressed as micromole Trolox equivalent (TE) per gram. In addition, the amount of phenolic compounds contained in the cranberry flavoring agent were measured and are expressed as mg gallic acid equivalent per gram. The anthocyanin content of the cranberry flavoring agent was also measured and is expressed as mg cyanidine-3-glucoside equivalent per gram. The antioxidant content of the cranberry flavoring agent is indicated below in Table 4.

TABLE 4

| | | |
|---|---|---|
| water-soluble antioxidant capacity | 96 | μmol TE/g |
| lipid-soluble antioxidant capacity | 12 | μmol TE/g |
| total antioxidant capacity | 108 | μmol TE/g |
| phenolics | 10.19 | mg/g |
| anthocyanins | 1.29 | mg/g |

### EXAMPLE 2

This example illustrates the preparation of a freeze dried grape flavoring agent.

Water and gum arabic, in the amounts indicated in the table below, were mixed in a rotosolver (Admix) at 1750 rpm for 5 minutes. Concord grape puree (Milne) was added to the mixture and blended for 1 minute, followed by the addition of grape concentrate, which was then blended for 1 minute. The mixture was then placed in a Ross high shear mixer and blended for 1 minute. Sugar was then added, the mixture was blended for 1 minute, then maltodextrin was added, followed by the grape pumice extract and grape flavor and the mixture was blended for an additional 1 minute. The mixture was dried and packaged as described in Example 1.

The grape flavoring agent formulation is indicated below in Table 5.

TABLE 5

| | Amount | Amount | |
|---|---|---|---|
| Ingredient | (dry %) | (wet %) | °Bx |
| concord grape puree | 5 | 9.7 | 45 |
| concord grape juice | 15 | 19.28 | 68 |
| concentrate | | | |
| maltodextrin | 40 | 36.8 | 95 |
| granulated sugar | 25.5 | 22.51 | 99 |
| pre-hydrated gum | 5 | 5.02 | 87 |
| arabic | | | |
| grape pumice extract | 5 | 4.5 | 97.2 |
| concord grape flavor | 2.5 | 2.19 | 100 |
| filtered water | 2 | 0 | 100 |
| total (%) | 100 | 100 | — |

The wet formulation had a citric acid % of 2.2721, and an uncorrected ° Bx of 52.9, resulting in a calculated, corrected ° Bx of 53.3.

### EXAMPLE 3

This example illustrates the preparation of a freeze dried pomegranate flavoring agent.

Water and gum arabic, in the amounts indicated in the table below, were mixed in a rotosolver (Admix) at 1750 rpm for 5 minutes. Pomegranate concentrate was added to the mixture and blended for 1 minute. The mixture was then placed in a Ross high shear mixer and blended for 1 minute. Sugar was then added, the mixture was blended for 1 minute, then maltodextrin was added, and the mixture was blended for an additional 1 minute. Pomegranate flavor and seed extract free of astaxantin (Valensa) were then added and the mixture was blended for 2 minutes. The mixture was dried and packaged as described in Example 1.

The pomegranate flavoring agent formulation is indicated below in Table 6.

TABLE 6

| | Amount | Amount | |
|---|---|---|---|
| Ingredient | (dry %) | (wet %) | °Bx |
| pomegranate juice | 15 | 20.91 | 65 |
| concentrate | | | |
| maltodextrin | 34 | 32.45 | 95 |
| granulated sugar | 18.975 | 17.38 | 99 |
| pre-hydrated gum arabic | 15 | 15.63 | 87 |
| pomegranate seed extract | 15 | 13.6 | 100 |
| pomegranate flavor | 0.025 | 0.2 | 100 |
| filtered water | 2 | 0 | 100 |
| total (%) | 100 | 100 | — |

The wet formulation had a citric acid % of 2.2721, and an uncorrected ° Bx of 52.9, resulting in a calculated, corrected ° Bx of 53.3.

### EXAMPLE 4

This example illustrates the preparation of a spray dried cranberry flavoring agent.

Water (having a temperature of about 160-180° F.) and gum arabic, in the amounts indicated in the table below, were mixed until all solids were dissolved. Maltodextrin was then added to the mixture which was again mixed until all solids dissolved. The mixture was then allowed to cool to a temperature of less than about 120° F. The cranberry seed extract and cranberry flavor were then added, and the mixture was blended until uniform. The mixture was homogenized and spray dried.

The cranberry flavoring agent formulation is indicated below in Table 7.

TABLE 7

| Ingredient | Wt. % |
|---|---|
| corn syrup solids | 473.68 |
| maltodextrin | 281.89 |
| pre-hydrated gum arabic | 106 |
| cranberry seed extract | 166 |
| cranberry flavor | 12.23 |
| filtered water | 1160.2 |

The formulation of the cranberry flavor used to prepare the spray dried flavoring agent is indicated below in Table 8.

TABLE 8

| Ingredient | Amount (%) |
|---|---|
| acetic acid | 0.1576 |
| butyl alcohol | 0.1726 |
| amyl alcohol | 1.984 |
| butyric acid | 1.887 |
| ethyl butyrate | 0.2376 |
| ethyl 2 methyl butyrate | 0.3924 |
| hexyl alcohol | 0.3924 |
| amyl acetate | 0.3066 |
| methyl butyric acid | 35.9016 |
| benzaldehyde | 1.6456 |
| iso amyl propionate | 0.397 |
| caproic acid | 4.454 |
| ethyl caproate | 0.164 |
| benzyl alcohol | 0.712 |
| amyl butyrate | 0.345 |
| linalool-bios de rose | 0.5676 |
| alpha fenchyl alcohol | 1.971 |
| benzyl acetate | 3.3534 |
| benzoic acid | 11.7156 |
| ethyl caprylate | 0.811 |
| L-alpha terpineol | 0.2416 |
| geranyl acetate | 0.647 |
| methyl cinnamate | 0.539 |
| dimethyl anthranilate | 2.4286 |
| gamma octalactone | 0.9706 |
| ethyl cinnamate | 2.804 |
| organic davana oil | 24.8012 |
| total | 100.9999 |

### EXAMPLE 5

This example illustrates the preparation of a liquid emulsion cranberry flavoring agent.

The cranberry flavor and seed extract, in the amounts indicated below, were combined. In a separate vessel, the water, sodium benzoate, sodium citrate, cranberry juice concentrate, and citric acid were added sequentially. The gum arabic was then added to the mixture while stirring. The mixture was then stirred for an additional 30 minutes. The cranberry flavor (the formulation of which is indicated above in Table 8)and seed extract mixture was then added to the mixture containing the other ingredients while stirring. The mixture was then stirred for an additional 5 minutes. The mixture was pre-homogenized using a high shear mixer for 5 minutes or until the particle size was reduced to about 3-5 microns. The mixture was then homogenized using 2 passes by a high shear mixer at pressures of 7000 and 1000 psi, respectively, to further reduce the particle size of the mixture to 0.01-0.25 microns.

The cranberry flavoring agent formulation is indicated below in Table 9.

TABLE 9

| Ingredient | Wt. % |
|---|---|
| cranberry juice concentrate | 50 |
| sodium citrate powder | 0.8 |
| sodium benzoate | 1 |
| citric acid monohydrate | 1.5 |
| spray dried gum arabic | 180 |
| cranberry seed extract | 71 |
| natural cranberry flavor | 2.5 |
| filtered water | 693.2 |

The liquid emulsion flavoring agent was then used to prepare a 5% sugar syrup for use in the preparation of beverages, and a cranberry juice cocktail beverage. The formulation of the syrup and beverage are indicated below in Tables 10 and 11, respectively. The beverage was pasteurized at 190-195° F. for 1-2 minutes and delivers about 100 mg omega-3 fatty acid per 8 fluid ounce serving. The syrup, when diluted in a 6000 ml beverage containing 2.8 volumes carbon dioxide, also delivers about 100 mg omega-3 fatty acid per 8 fluid ounce serving.

TABLE 10

| Ingredient | Amount | |
|---|---|---|
| sodium benzoate | 1.5 | g |
| citric acid | 4.5 | g |
| sucrose | 305 | g |
| cranberry | 120 | ml |
| emulsion | | |
| water | add until total volume reaches 1000 ml | |
| total (ml) | 1000 | |

TABLE 11

| Ingredient | Amount | |
|---|---|---|
| cranberry juice concentrate | 33.96 | ml |
| cranberry emulsion | 20 | ml |
| high fructose corn syrup | 97.35 | ml |
| ascorbic acid | 0.31 | g |
| water | add until total volume reaches 1000 ml | |
| total (ml) | 1000 | |

### EXAMPLE 6

This example illustrates the oxygen radical absorbance capacity (ORAC) of various extracts prepared from tea, rooibos, camomile, and citrus sources and the use of such extracts in a soft drink formulation.

Extracts from the sources indicated below in Table 12 were prepared using either maceration, sedimentation, and ultrafiltration, or distillation. Each extract was then concentrated and spray dried.

The oxygen radical absorbance capacity (ORAC) of each extract was measured and is indicated below in Table 12.

TABLE 12

| | ORAC |
|---|---|
| Source | (μmol TE/g) |
| green tea leaves | 1518 |
| black tea leaves | 2767 |
| green & black tea | 1801 |
| leaves mixture | |
| rooibos leaves | 3082 |
| camomile flowers | 467 |
| citrus peel | 413 |

Six different soft drinks comprising each of the extracts were developed and the formulations are indicated below in Table 13.

TABLE 13

| Ingredient | Amount | |
|---|---|---|
| water | to 11 | |
| sodium benzoate | 0.15 | g |
| potassium sorbate | 0.2 | g |
| sugar | 70 | g |
| citric acid monohydrate | 1.5 | g |

| | | | |
|---|---|---|---|
| extract: | green tea | 4.2 | g/l |
| | leaves | | |
| | black tea | 6.5 | g/l |
| | leaves | | |
| | green & black | 6.6 | g/l |
| | tea leaves | | |
| | mixture | | |
| | rooibos leaves | 4 | g/l |
| | camomile | 4 | g/l |
| | flowers | | |
| | citrus peel | 10 | g/l |

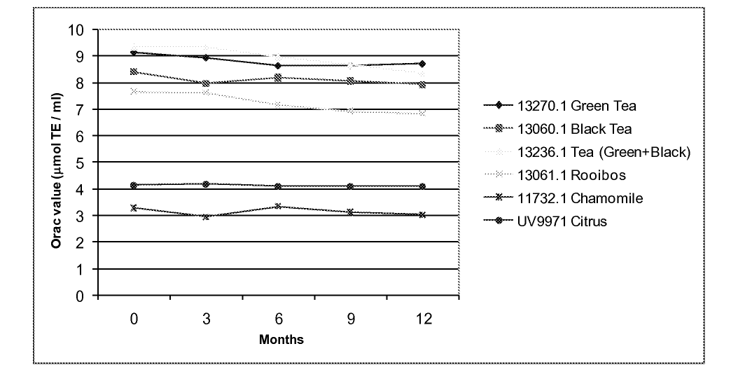

In order to evaluate the shelf life of the soft drinks, each soft drink formulation was placed in a 0.51 PET bottle in a stability room having a temperature of 35° C., humidity of 65%, and varying levels of light exposure to simulate time spent on the shelf [90 Klux (3 months), 180 Klux (6 months), 270 Klux (9 months), and 365 Klux (12 months)]. The ORAC of each soft drink was measured at 0, 3, 6, 9, and 12 months and the results are shown in FIG. 1. This data was then used to prepare a statistical analysis (ANOVA) of the variance in ORAC levels over time for each soft drink, shown below in Table 14.

TABLE 14

| | Simulated Shelf-Life (months) | | | | | Anova Resutls |
|---|---|---|---|---|---|---|
| Source | 0 | 3 | 6 | 9 | 12 | (α = 0.05) |
| green tea | 9.16 | 8.95 | 8.65 | 8.67 | 8.72 | no significant |
| leaves | | | | | | differences |
| black tea | 8.41 | 7.98 | 8.19 | 8.07 | 7.94 | T = 12 significant |
| leaves | | | | | | differences |
| green & black | 9.34 | 9.36 | 8.98 | 8.68 | 8.37 | T = 12 significant |
| tea leaves | | | | | | differences |
| mixture | | | | | | |
| rooibos leaves | 7.67 | 7.64 | 7.16 | 6.93 | 6.85 | T = 9 significant |
| | | | | | | differences |
| camomile | 3.29 | 2.94 | 3.34 | 3.12 | 3.02 | T = 12 significant |
| flowers | | | | | | differences |
| citrus peel | 4.15 | 4.18 | 4.11 | 4.11 | 4.10 | no significant |
| | | | | | | differences |

The data set forth in Table 14 shows that the ORAC levels of the soft drinks comprising green tea and citrus showed no significant differences over a simulated shelf life of 12 months. Significant differences in ORAC value were observed for the soft drinks comprising black tea, the green and black tea mixture, and chamomile at a time of 12 months and for the soft drink comprising rooibos at a time of 9 months.

The caffeine content of the soft drinks comprising green tea, black tea, and a mixture of green and black tea at 0, 3, 6, 9, and 12 months was measured using high performance liquid chromatography (HPLC) (Hewlet Packard Model 1100 Agilent) and is shown below in Table 15.

TABLE 15

| Caffeine (%) | Simulated Shelf-Life (months) | | | | |
|---|---|---|---|---|---|
| Source | 0 | 3 | 6 | 9 | 12 |
| green tea leaves | 0.013 | 0.013 | 0.013 | 0.013 | 0.013 |
| black tea leaves | 0.01 | 0.01 | 0.01 | 0.01 | 0.01 |
| green & black tea | 0.009 | 0.009 | 0.009 | 0.009 | 0.009 |
| leaves mixture | | | | | |

The data set forth in Table 15 shows that the caffeine levels of the soft drinks comprising the green tea leaves, black tea leaves, and mixture of green and black tea leaves remained stable over a simulated shelf life of 12 months.

1. A flavoring agent comprising fruit seed extract, vegetable seed extract, or a combination thereof, wherein the seed extract contains omega fatty acids and antioxidants extracted from fruit and/or vegetable seeds and the agent is substantially free of non-natural preservatives.

2. The flavoring agent of claim 1, wherein the agent is substantially free of non-natural colors.

3. The flavoring agent of claim 1, wherein the agent is substantially free of non-natural solvents.

4. The flavoring agent of claim 1, wherein the agent is substantially free of chemically modified food starches.

5. The flavoring agent of claim 1, wherein the agent further comprises fruit or vegetable juice.

6. The flavoring agent of claim 1, wherein the agent further comprises fruit or vegetable extract.

7. The flavoring agent of claim 1, wherein the agent further comprises fruit or vegetable skin.

8. The flavoring agent of claim 1, wherein the agent further comprises fruit or vegetable flavor.

9. The flavoring agent of claim 1, wherein the seed extract is grape and comprises polyphenols.

10. The flavoring agent of claim 1, wherein the seed extract is pomegranate and comprises an omega-5 fatty acid glycerol ester.

11. The flavoring agent of claim 1, wherein the agent has a ratio of omega-3 fatty acid to omega-6 fatty acid of about 1:5 to about 5:1.

12. The flavoring agent of claim 1, wherein the agent has at least about 8 mg of phenolic compounds per gram flavoring agent.

13. The flavoring agent of claim 1, wherein the agent has at least about 1 mg of anthocyanin compounds per gram flavoring agent.

14. The flavoring agent of claim 1, wherein the agent has an antioxidant capacity of 90 μmol trolox equivalents per gram flavoring agent.

15. A dietary supplement comprising the flavoring agent of claim 1.

16. An edible food product comprising the flavoring agent of claim 1.

17. A process for preparing the flavoring agent of claim 1 comprising preparing the fruit and/or vegetable seed extract by super critical CO₂ extraction.

18. A flavoring agent comprising animal tissue or flesh extract, leaf extract, bark extract, herbaceous compound extract, or combinations thereof, wherein the extract contains omega fatty acids and antioxidants extracted from animal tissue or flesh, leaf, bark, and/or herbaceous compound and the agent is substantially free of non-natural preservatives.

19. The flavoring agent of claim 18, wherein the agent is substantially free of non-natural colors.

20. The flavoring agent of claim 18, wherein the agent is substantially free of non-natural solvents.

21. The flavoring agent of claim 18, wherein the agent is substantially free of chemically modified food starches.

22. The flavoring agent of claim 18, wherein the agent has a ratio of omega-3 fatty acid to omega-6 fatty acid of about 1:5 to about 5:1.

23. The flavoring agent of claim 18, wherein the agent has at least about 8 mg of phenolic compounds per gram flavoring agent.

24. The flavoring agent of claim 18, wherein the agent has at least about 1 mg of anthocyanin compounds per gram flavoring agent.

25. The flavoring agent of claim 18, wherein the agent has an antioxidant capacity of 90 μmol trolox equivalents per gram flavoring agent.

26. A dietary supplement comprising the flavoring agent of claim 18.

27. An edible food product comprising the flavoring agent of claim 18.
